(19) United States
(12) Patent Application Publication
(10) Pub. No.: US 2021/0325718 A1
(43) Pub. Date: Oct. 21, 2021

(54) DISPLAY PANEL AND DISPLAY DEVICE

(71) Applicant: TCL China Star Optoelectronics Technology Co., Ltd., Shenzhen (CN)

(72) Inventor: Qian LI, Shenzhen (CN)

(73) Assignee: TCL China Star Optoelectronics Technology Co., Ltd., Shenzhen (CN)

(21) Appl. No.: 16/627,348

(22) PCT Filed: Dec. 23, 2019
(86) PCT No.: PCT/CN2019/127396

§ 371 Date: Dec. 30, 2019

(30) Foreign Application Priority Data
Dec. 12, 2019 (CN) 201911270914.9

(51) Int. Cl. G02F 1/1335; G02F 1/1333; G02F 1/1337; G02F 1/1368

(52) U.S. Cl. CPC G02F 1/133504; G02F 1/133514; G02F 1/133305; G02F 2202/36; G02F 1/1337; G02F 1/1368; G02F 1/133528

(57) ABSTRACT

The display panel and the display device are provided by the present invention, and the display device includes a first substrate; a second substrate disposed opposite to and above the first substrate, wherein a color resist layer is disposed in the first substrate or the second substrate, and the second substrate includes an organic layer disposed above the color resist layer, wherein the organic layer is doped with nanoparticles; and a liquid crystal layer disposed between the first substrate and the second substrate. The display panel and the display device of the present invention can improve production efficiency.

### BACKGROUND OF INVENTION

### Field of Invention

The present invention relates to a field of display technology, and in particular, to a display panel and a display device.

### Description of Prior Art

Liquid crystal display panels are common displays on the market today, which can be divided into TN, STN, VA, and IPS display modes according to their driving modes. Compared with other display modes, the VA display mode has advantages of high contrast, high transmittance, and so on, but it is prone to color shift at large viewing angles, thereby reducing the display effect.

One of the main reasons for the color shift is that the brightness variations of R, G, and B between a side viewing angle and a front viewing angle are different. For example, some panels may have higher brightness ratio in R (G or B) at the side viewing angle than that at the front viewing angle, causing color shift problems. In order to solve the problem of color shift at large viewing angle, liquid crystals are deflected at different angles by applying different voltages to a main pixel area and a sub pixel area, thereby reducing a difference in brightness between the side viewing angle and the front viewing angle, or liquid crystals are deflected at different angles by changing a structure of the pixel to reduce the color shift. However, the above methods need to improve the pixel structure, which leads to a more complicated manufacturing process, thus reducing the production efficiency.

Therefore, there is a need to provide a display panel and a display device to solve the problems existing in the prior art.

### SUMMARY OF INVENTION

An object of the present invention is to provide a display panel and a display device, which can simplify the manufacturing process and improve the production efficiency.

In order to solve the above technical problems, the present invention provides a display panel, including:

a first substrate;

a second substrate disposed opposite to and above the first substrate, wherein a color resist layer is disposed in the first substrate or the second substrate, and the second substrate includes an organic layer disposed above the color resist layer, wherein the organic layer is doped with nanoparticles; and

a liquid crystal layer disposed between the first substrate and the second substrate.

The present invention also provides a display device including the above display panel.

Beneficial effects of the present application are that: the display panel and the display device are provided by the present invention, and the display device includes a first substrate; a second substrate disposed opposite to and above the first substrate, wherein a color resist layer is disposed in the first substrate or the second substrate, and the second substrate includes an organic layer disposed above the color resist layer, wherein the organic layer is doped with nanoparticles; and a liquid crystal layer disposed between the first substrate and the second substrate. The nanoparticles can scatter light of a specific wavelength to reduce a difference in brightness of light of the three primary colors between a front viewing angle and a side viewing angle, thereby improving color shift, and since there is no need to improve the pixel structure, the manufacturing process is simplified and the production efficiency is improved.

### BRIEF DESCRIPTION OF DRAWINGS

FIG. 1 is a schematic structural diagram of a display panel according to a first embodiment of the present invention.

FIG. 2 is a schematic structural diagram of a display panel according to a second embodiment of the present invention.

FIG. 3 is a schematic diagram of a preferred structure of a display panel according to the second embodiment of the present invention.

### DETAILED DESCRIPTION OF PREFERRED EMBODIMENTS

The following description of the various embodiments is provided to illustrate the specific embodiments of the invention. The spatially relative directional terms mentioned in the present invention, such as “upper”, “lower”, “before”, “after”, “left”, “right”, “inside”, “outside”, “side”, etc. and the like, may be used herein for ease of description to describe one element or feature's relationship to another element(s) or feature(s) as illustrated in the figures which are merely references. The spatially relative terms are intended to encompass different orientations in addition to the orientation as depicted in the figures.

The terms “first”, “second”, and the like in the description and claims of the present application and the above-mentioned drawings are used to distinguish different objects, and are not used to describe a specific order. Furthermore, the terms “including” and “having”, as well as any variation thereof, are intended to cover non-exclusive inclusion.

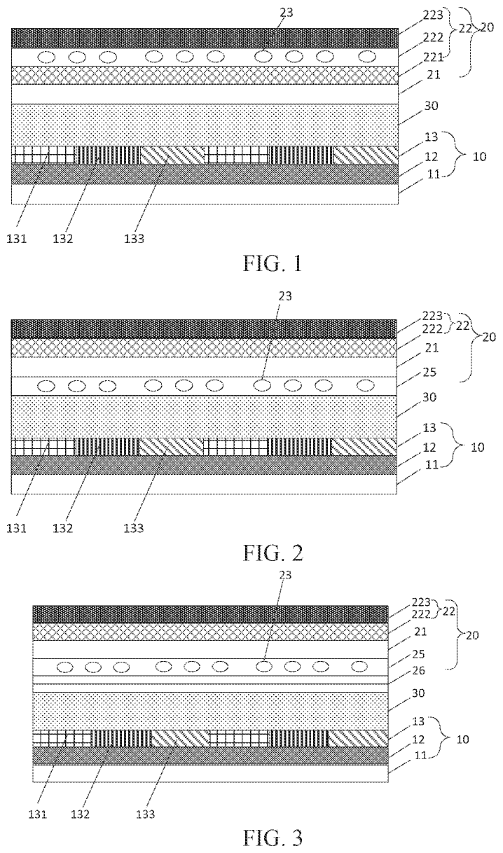

Referring to FIG. 1, a display panel according to a first embodiment of the present invention includes a first substrate 10, a second substrate 20, and a liquid crystal layer 30.

In an embodiment, the first substrate 10 includes a first base substrate 11 and a switch array layer 12. The switch array layer 12 is disposed on the first base substrate 11. The switch array layer 12 may include a plurality of thin film transistors. A cross-sectional structure of the switch array layer 12 may include a gate, a source, a drain, a semiconductor layer, and the like. In other embodiments, the first substrate 10 may further include a color resist layer 13 disposed on the switch array layer 12. The color resist layer 13 includes a plurality of first color resists 131, a plurality of second color resists 132, and a plurality of third color resists 133. In an embodiment, the first color resists 131, the second color resists 132, and the third color resist 133 are red color resists, green color resists, and blue color resists, respectively.

A second substrate 20 is disposed opposite to the first substrate 10, and the second substrate 20 is disposed on the first substrate 10. The second substrate 20 includes a second base substrate 21, a polarizing film 22. The polarizing film 22 is disposed in a top of the second substrate 20, and the polarizing film 22 includes an organic layer 222 located on the second base substrate 21. The organic layer 22 is doped with nanoparticles 23, and can be made of an organic material commonly used in a display panel, such as a polyvinyl alcohol (PVA) layer.

In an embodiment, in order to better improve the color shift, and each of the nanoparticles 23 has a shell with a diameter ranging from 0 nm to 200 nm and a core with a diameter ranging from 0 nm to 400 nm. When the sizes of the nanoparticles are within this range, the brightness of the overall positive viewing angle can be reduced, while the brightness of the side viewing angle can be increased, and thus the color shift can be better improved. In an embodiment, in order to better improve the color shift, the material of the core of the nanoparticles 23 may include at least one of Ag and Au, and the material of the shell of the nanoparticles 23 may include at least one of SnO₂, MnO₂, CrO, and ZnO.

Taking the Ag@TiO₂ nanoparticles as an example, for example, during a specific preparation process, the Ag@TiO2 nanoparticles can be dissolved in isopropanol (IPA), which is then added to the PVA solution and stirred to dissolve the nanoparticles uniformly in PVA, then, the solution is applied on the corresponding layer by spin-coating, followed by a low-temperature drying treatment, to obtain an organic layer doped with nanoparticles.

The raw materials of the nanoparticles can scatter light of three primary colors of R, G, and B by selecting different core-shell sizes, wherein the size of the shell is 0 to 200 nm, the size of the core is 0 to 400 nm, the core can be selected from a metal such as Ag, Au, and the like, and the shell can be selected from a transition metal oxide such as SnO₂, MnO₂, CrO, ZnO, and the like.

In an embodiment, the polarizing film 22 further includes a polarizing layer 221 and a protective layer 223, wherein the protective layer 223 is located above the polarizing layer 221, and the organic layer 222 is located between the polarizing layer 221 and the protective layer 223. Of course, the arrangement of the organic layer 222 is not particularly limited thereto, and the organic layer 222 can be placed at any position in the polarizing film, such as being disposed above the protective layer (stripping protective layer) of the polarizing film, and the like.

The liquid crystal layer 30 is disposed between the first substrate 10 and the second substrate 20.

Referring to FIG. 2 and FIG. 3. The display panel provided by the second embodiment of the present invention includes the following differences from the previous embodiment:

As shown in FIGS. 2 and 3, the organic layer 25 in this embodiment is disposed below the second base substrate 21, that is, on a side of the second substrate 20 close to the liquid crystal layer 30. In an embodiment, the second substrate 20 may further include a second alignment film 26, and the organic layer 25 is located between the second base substrate 21 and the second alignment film 26.

It can be understood that the structure of the display panel is not particularly limited to the above structure. For example, in other embodiments, a color resist layer is provided on the second substrate, and an organic layer may be further disposed above the color resist layer, that is, light passes through the color resist layer first and then emits through the organic layer. In addition, it is recognized that the organic layer is not suitable to be placed above or below the electrode (ITO) to avoid impacting its conductive performance.

Since the present invention provides an organic layer doped with nanoparticles on the upper substrate, wherein the nanoparticles have a function of localized surface plasmon resonance (LSPR), which can scatter light at a specific wavelength, such as scattering red light (G light, B light) transmitted through the substrate, the difference in brightness of the red light (G, B) in the positive viewing angle and in the side viewing angle and the difference in brightness of light of the three primary colors in the front viewing angle and the side viewing angle can be reduced, thereby improving color shift. In addition, since there is no need to improve the pixel structure, the manufacturing process is simplified and the production efficiency is improved.

The present invention also provides a display device, which includes any one of the display panels described above. In addition, the display device may further include a backlight module.

The display panel and the display device are provided by the present invention, and the display device includes a first substrate; a second substrate disposed opposite to and above the first substrate, wherein a color resist layer is disposed in the first substrate or the second substrate, and the second substrate includes an organic layer disposed above the color resist layer, wherein the organic layer is doped with nanoparticles; and a liquid crystal layer disposed between the first substrate and the second substrate. The nanoparticles can scatter light of a specific wavelength to reduce a difference in brightness of light of the three primary colors between a front viewing angle and a side viewing angle, thereby improving color shift, and since there is no need to improve the pixel structure, the manufacturing process is simplified and the production efficiency is improved.

While the invention has been described by way of example and in terms of the preferred embodiments, it is to be understood that the invention is not limited to the disclosed embodiments. To the contrary, it is intended to cover various modifications and similar arrangements. Therefore, the scope of the appended claims should be accorded the broadest interpretation so as to encompass all such modifications and similar arrangements.

What is claimed is:

1. A display panel, comprising:
a first substrate;
a second substrate disposed opposite to and above the first substrate, wherein a color resist layer is disposed in the first substrate or the second substrate, and the second substrate comprises an organic layer disposed above the color resist layer, wherein the organic layer is doped with nanoparticles; and
a liquid crystal layer disposed between the first substrate and the second substrate,
wherein the second substrate further comprises a polarizing film disposed in a top of the second substrate, the organic layer is located in the polarizing film, the nanoparticles are spherical nanoparticles, and each of the nanoparticles has a shell with a diameter ranging from 0 nm to 200 nm and a core with a diameter ranging from 0 nm to 400 nm.

2. A display panel, comprising:
a first substrate;
a second substrate disposed opposite to and above the first substrate, wherein a color resist layer is disposed in the first substrate or the second substrate, and the second substrate comprises an organic layer disposed above the color resist layer, wherein the organic layer is doped with nanoparticles; and
a liquid crystal layer disposed between the first substrate and the second substrate.

3. The display panel according to claim 2, wherein
the second substrate further comprises a polarizing film disposed in a top of the second substrate, and the organic layer is located in the polarizing film.

4. The display panel according to claim 2, wherein
the polarizing film comprises a polarizing layer and a protective layer disposed on the polarizing layer, and the organic layer is disposed on the protective layer.

5. The display panel according to claim 2, wherein
the color resist layer is disposed on the first substrate, and the organic layer is disposed on a side of the second substrate close to the liquid crystal layer.

6. The display panel according to claim 5, wherein
the second substrate further comprises a second base substrate and a second alignment film disposed under the second base substrate, and the organic layer is located between the second base substrate and the second alignment film.

7. The display panel according to claim 5, wherein
the first substrate comprises a first base substrate and a switch array layer disposed on the first base substrate, and the color resist layer is disposed on the switch array layer.

8. The display panel according to claim 2, wherein
the nanoparticles are spherical nanoparticles, and each of the nanoparticles has a shell with a diameter ranging from 0 nm to 200 nm and a core with a diameter ranging from 0 nm to 400 nm.

9. The display panel according to claim 8, wherein
a material of the core of each of the nanoparticles comprises at least one of Ag and Au.

10. The display panel according to claim 8, wherein
a material of the shell of each of the nanoparticles comprises at least one of SnO₂, MnO₂, CrO, and ZnO.

11. A display device, comprising a display panel; the display panel comprising:
a first substrate;
a second substrate disposed opposite to and above the first substrate, wherein a color resist layer is disposed in the first substrate or the second substrate, and the second substrate comprises an organic layer disposed above the color resist layer, wherein the organic layer is doped with nanoparticles; and
a liquid crystal layer disposed between the first substrate and the second substrate.

12. The display device according to claim 11, wherein
the second substrate further comprises a polarizing film disposed in a top of the second substrate, and the organic layer is located in the polarizing film.

13. The display device according to claim 11, wherein
the polarizing film comprises a polarizing layer and a protective layer disposed on the polarizing layer, and the organic layer is disposed on the protective layer.

14. The display device according to claim 11, wherein
the color resist layer is disposed on the first substrate, and the organic layer is disposed on a side of the second substrate close to the liquid crystal layer.

15. The display device according to claim 14, wherein
the second substrate further comprises a second base substrate and a second alignment film disposed under the second base substrate, and the organic layer is located between the second base substrate and the second alignment film.

16. The display device according to claim 14, wherein
the first substrate comprises a first base substrate and a switch array layer disposed on the first base substrate, and the color resist layer is disposed on the switch array layer.

17. The display device according to claim 11, wherein
the nanoparticles are spherical nanoparticles, and each of the nanoparticles has a shell with a diameter ranging from 0 nm to 200 nm and a core with a diameter ranging from 0 nm to 400 nm.

18. The display device according to claim 17, wherein
a material of the core of each of the nanoparticles comprises at least one of Ag and Au.

19. The display device according to claim 17, wherein
a material of the shell of each of the nanoparticles comprises at least one of SnO₂, MnO₂, CrO, and ZnO.
